(19) United States
(12) Patent Application Publication
(10) Pub. No.: US 2009/0066179 A9
(43) Pub. Date: Mar. 12, 2009

(54) DIRECT CURRENT MOTOR

(75) Inventors: Yoshiki NAKANO, Hamamatsu-shi (JP); Kuniaki MATSUMOTO, Hamamatsu-shi (JP)

Correspondence Address: AKERMAN SENTERFITT, P.O. BOX 3188, WEST PALM BEACH, FL, 33402-3188, US

(73) Assignee: ASMO Co., Ltd., Kosai-shi (JP)

(21) Appl. No.: 12/061,793

(22) Filed: Apr. 3, 2008

(30) Foreign Application Priority Data
Apr. 4, 2007 (JP) 2007-098622

(51) Int. Cl. H02K 23/20

(52) U.S. Cl. 310/148; 310/177

(57) ABSTRACT

A slide surface of each segment defines a plane orthogonal to an axial direction of a direct current motor. A power supply brush is pressed against and contacted with the slide surface. The power supply brush includes a main brush and a sub-brush. The sub- brush has electrical resistance that is higher than that of the main brush. At least the main brush supplies an armature with power. The sub-brush is arranged more inward in the radial direction of the commutator than the main brush.

### BACKGROUND OF THE INVENTION

The present invention relates to a direct current motor. A direct current motor includes an armature, which has a commutator, and a power supply brush, which supplies power to the armature through the commutator.

The power supply brush supplies power to the armature by sliding along contact surfaces of a plurality of segments provided for the commutator. Japanese Laid-Open Patent Publication No. 9-74721describes a power supply brush which is pressed by the armature in an axial direction. The contact surface is a plane orthogonal to the axial direction of the direct current motor.

When the power supply brush starts to slide along the commutator segments or moves away from the segments, there is a tendency for sparks to occur. Sparks cause the power supply brush to easily wear. To prolong the life of the power supply brush, the dimensions of the power supply brush in a direction orthogonal to the contact surface may be increased. However, this would enlarge the motor and thus is not an appealing solution.

Japanese Laid-Open Patent Publication No. 2003-348800 discloses a main anode brush, a main cathode brush, a sub-anode brush, and a sub-cathode brush that prevent sparks in a power supply brush. The circumferential interval between the sub-anode brush and the main anode brush is set to be shifted by a slight amount from the circumferential interval between segments having the same potential. As a result, the timing at which the sub-anode brush moves away from a certain segment is delayed from a timing at which the main anode brush moves away from a segment having the same potential as that segment. This prevents sparks from the main anode brush.

However, adjustment of the circumferential interval between the sub-anode brush and the main anode brush is complicated.

### SUMMARY OF THE INVENTION

It is an object of the present invention to provide a direct current motor that facilitates the setting of the arrangement and dimensions of the power supply brush when preventing sparks in the power supply brush.

One aspect of the present invention provides a direct current motor which defines an axial direction and a radial direction. The direct current motor has a commutator including a plurality of segments. The segments are arranged in a circumferential direction. Each of the segments includes a slide surface defined by a plane orthogonal to the axial direction. A power supply brush is pressed against and contacts the slide surface. An armature is supplied with power for rotation from the power supply brush via the commutator. The power supply brush includes a main brush and a sub-brush. The sub-brush has electrical resistance that is higher than that of the main brush. At least the main brush supplies the armature with power. The sub-brush is arranged more inward in a radial direction of the commutator than the main brush.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a cross-sectional view of a direct current motor according to one embodiment of the present invention;

FIG. 2A is a partial perspective view showing an axial end of a tooth shown in FIG. 1;

FIG. 2B is a partial perspective view showing an axial end of the tooth of FIG. 2A and a segment of a commutator;

FIG. 3 is a cross-sectional view of the commutator shown in FIG. 1 and is taken along line 3-3 in FIG. 4;

FIG. 4 is a diagram showing the positional relationship of twenty-four segments and four brushes;

FIG. 5 is a plan view showing the position relationship of twenty-four segments and twenty-four short-circuiting members;

FIG. 6 is a connection wiring diagram of the direct current motor of FIG. 1;

FIG. 7A is a perspective view of the twenty-four short-circuiting members;

FIG. 7B is a perspective view of the twenty-four segments; and

FIG. 8 is an exploded perspective view of an armature.

### DETAILED DESCRIPTION OF THE PREFERRED EMBODIMENTS

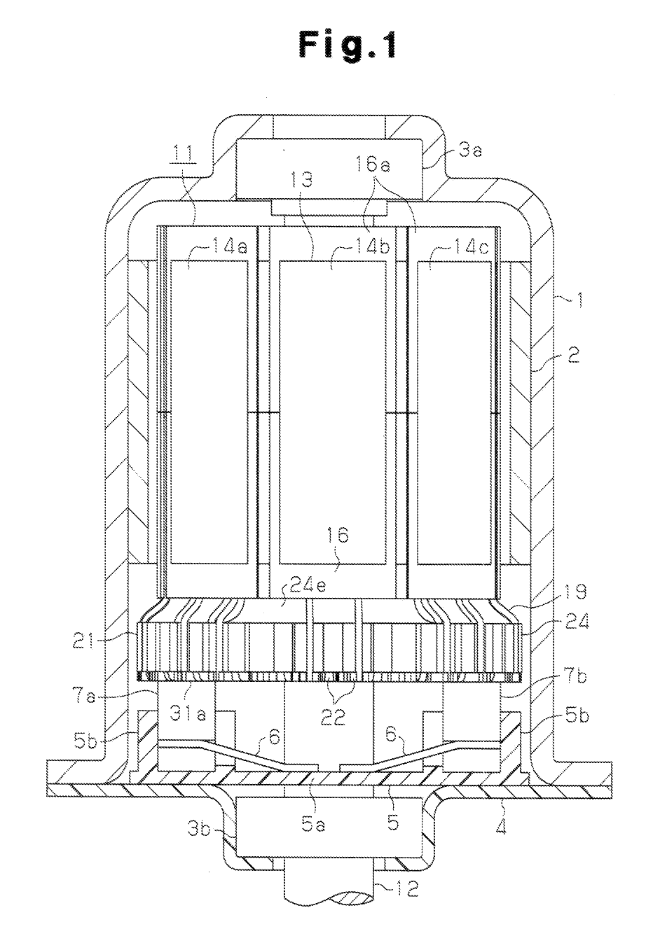

FIGS. 1 to 8 show a direct current motor according to one embodiment of the present invention.

As shown in FIG. 1, the direct current motor includes a cylindrical motor housing 1 having a closed bottom and a plurality of magnets 2 fixed to an inner circumferential surface of the motor housing 1. The magnets 2 form six magnetic poles. A first bearing 3a is arranged at the center of the bottom of the motor housing 1. A generally disk-shaped end frame 4 closes an opening of the motor housing 1. The motor housing 1 and the end frame 4 rotatably accommodate an armature 11. A second bearing 3b is arranged at the center of the end frame 4. The first bearing 3a and the second bearing 3b rotatably support a rotation shaft 12 of the armature 11.

A brush holder 5 facing towards the motor housing 1 is arranged on the end frame 4. The brush holder 5 includes a fixed plate 5a and four brush holding units 5b arranged on the fixed plate 5a. The fixed plate 5a, which is disk-shaped, is fixed to the end frame 4. Each brush holding unit 5b is square-pillar shaped, extending in the axial direction, and is integrally formed with the fixed plate 5a. A plate spring 6 is provided for each brush holding unit 5b. The brush holding units 5b are arranged at predetermined intervals in the circumferential direction along the same circumference about the center of the fixed plate 5a.

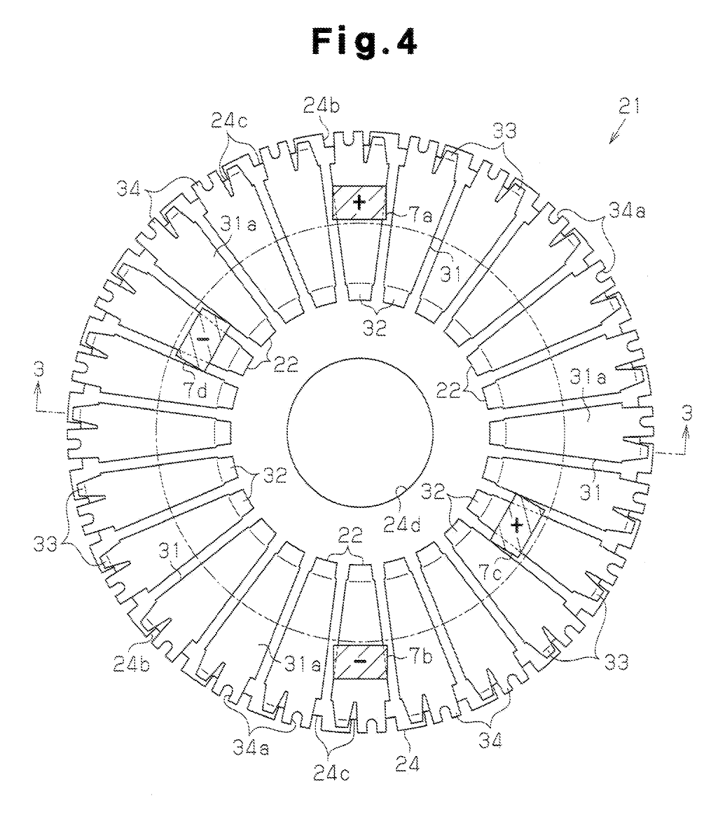

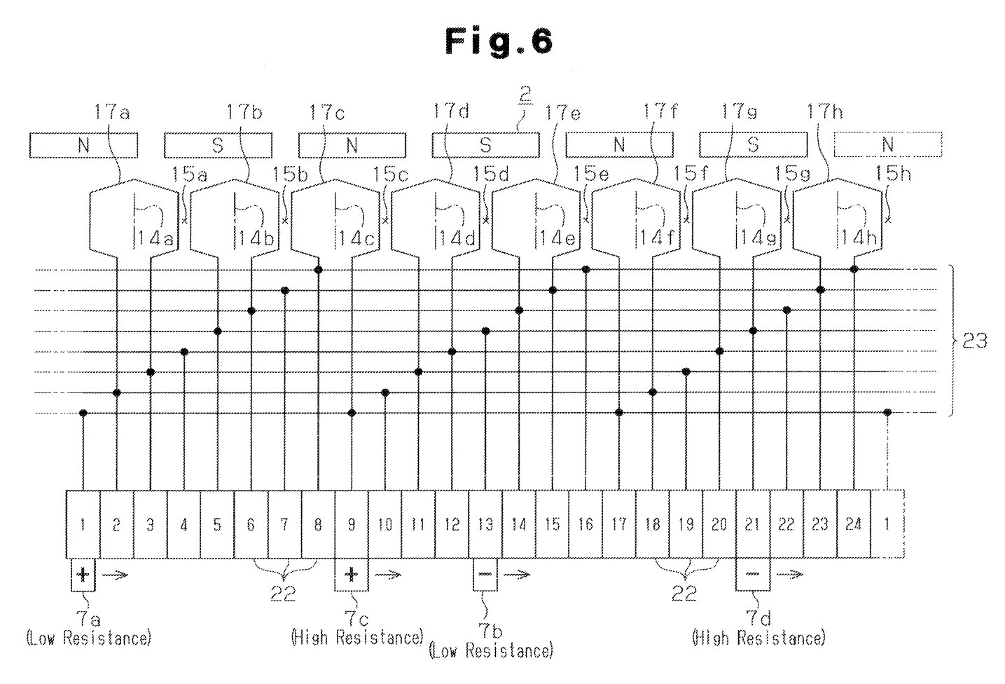

As shown in FIGS. 4 and 6, the direct current motor includes a main anode brush 7a, a main cathode brush 7b, a sub-anode brush 7c, and a sub-cathode brush 7d. The brush holding units 5b respectively accommodate the brushes 7a to 7d. The plate spring 6 biases the corresponding brushes 7a to 7d towards the commutator 21 for contact with the commutator 21.

The brushes 7a to 7d serve as a power supply brush, have generally box-like shapes, and are identical in shape and size to one another. The brushes 7a to 7d each have a distal end surface that slides along the armature 11. The distal end surfaces of the brushes 7a to 7d are rectangular and identical in shape and size to one another. The long side of each distal end surface is orthogonal to the radial direction of the armature 11. The short side of each distal end surface extends parallel to the radial direction of the armature 11.

The main material of a typical power supply brush is graphite powder and copper powder. Graphite powder is mixed with copper powder and then sintered to form the typical power supply brush.

The main anode brush 7a is formed as a low resistance brush having a higher electrical resistance than the sub-anode brush 7c. In the same manner, the main cathode brush 7b is formed as a low resistance brush having a higher electrical resistance than the sub-cathode brush 7d. The main anode brush 7a and the main cathode brush 7b contain about 50% by weight of copper powder. The sub-anode brush 7c and the sub- cathode brush 7d of the present embodiment are formed as high resistance brushes and contain about 100% by weight of graphite powder. The sub-anode brush 7c and the sub-cathode brush 7d are formed without mixing copper powder.

As shown in FIGS. 4 and 6, the main anode brush 7a and the main cathode brush 7b are arranged at an interval of 180° in the circumferential direction. That is, the main anode brush 7a and the main cathode brush 7b are arranged at opposing positions with the rotation shaft 12 located in between. The sub-anode brush 7c is arranged at an interval of 120° from the main anode brush 7a. The sub-cathode brush 7d is arranged at an interval of 120° from the main cathode brush 7b. The sub-anode brush 7c and the sub-cathode brush 7d are arranged at opposing positions with the rotation shaft 12 located in between. In this manner, the sub-anode brush 7c and the sub-cathode brush 7d are arranged in correspondence with the main anode brush 7a and the main cathode brush 7b.

As shown in FIGS. 4 and 6, the sub-anode brush 7c is arranged inward from the main anode brush 7a in the radial direction of the commutator 21. In the same manner, the sub-cathode brush 7d is arranged inward from the main cathode brush 7b in the radial direction of the commutator 21. The sub-anode brush 7c and sub- cathode brush 7d are arranged inward in the radial direction of the commutator 21 from a circle indicated by a broken line in FIG. 4, and the main anode brush 7a and main cathode brush 7b are arranged radially outward from the circle. The sliding paths of the sub-anode brush 7c and the sub-cathode brush 7d are set so as not to overlap the sliding paths of the main anode brush 7a and the main cathode brush 7b. The sub-anode brush 7c and the sub-cathode brush 7d function to prevent sparks from the main anode brush 7a and the main cathode brush 7b and to suppress wear of the main anode brush 7a and the main cathode brush 7b.

The main anode brush 7a and the main cathode brush 7b are electrically connected by wires to an external power supply. However, the sub-anode brush 7c and the sub-cathode brush 7d are not connected to the external power supply. That is, the main anode brush 7a and the main cathode brush 7b are directly supplied with drive current from the external power supply. However, the sub-anode brush 7c and the sub-cathode brush 7d are not directly supplied with current from the external power supply.

Parts of the direct current motor other than the brushes 7a to 7d will now be described.

As shown in FIG. 1, the rotation shaft 12 has one end projecting out of the end frame 4 through the second bearing 3b. The armature 11 includes a core 13 and the commutator 21, which are fixed to the rotation shaft 12. The commutator 21 is located between the core 13 and the brush holder 5.

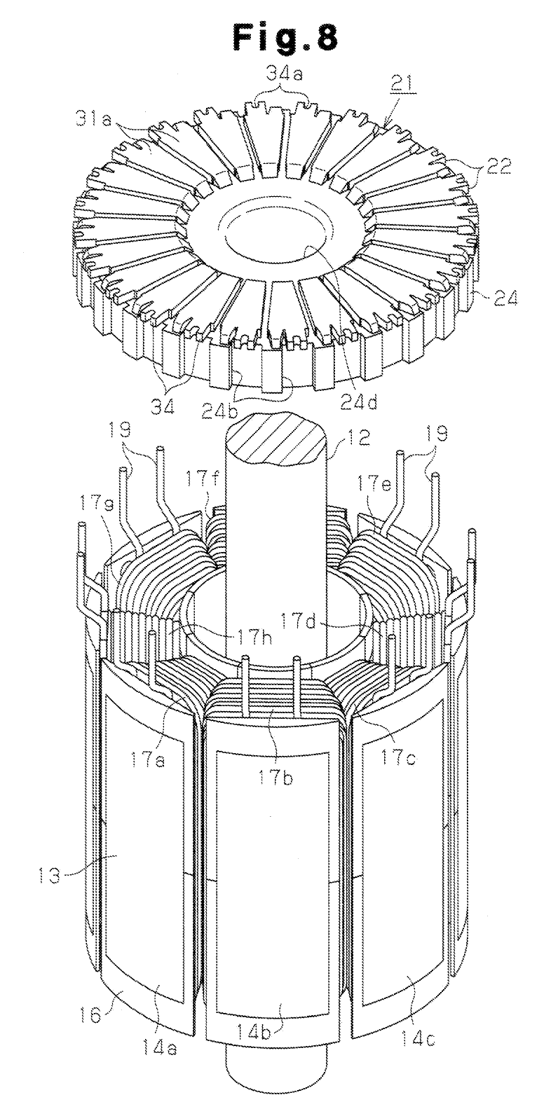

As shown in FIGS. 6 and 8, the core 13 includes eight radially extending teeth 14a to 14h. Slots 15a to 15h are defined between the adjacent ones of the teeth 14a to 14h. Two insulators 16 are attached to the core 13 in the axial direction. Coils 17a to 17h are respectively wound in a concentrated manner to the teeth 14a to 14h on the insulators 16. The radially outer ends of the insulators 16 include overhang prevention walls 16a, which extend in the axial direction, for each of the teeth 14a to 14h. The overhang prevention walls 16a prevent overhanging of the coils 17a to 17h.

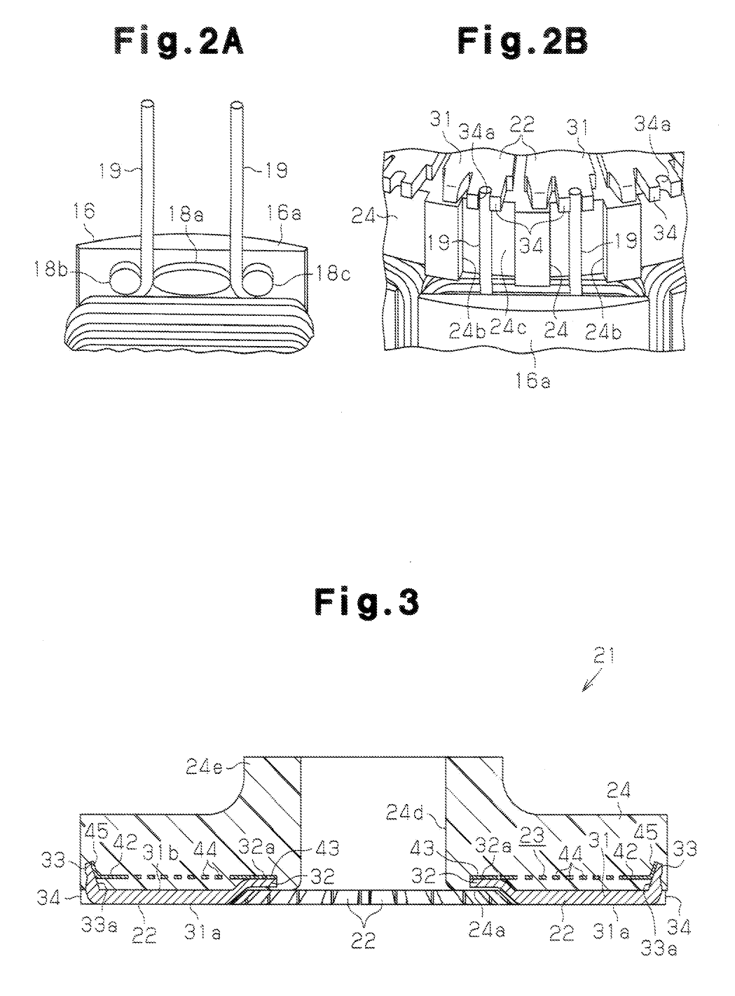

As shown in FIG. 2A, each overhang prevention wall 16a has an axial end including first holding projection 18a to third holding projection 18c, which project radially inward. The first holding projection 18a is located between the second holding projection 18b and the third holding projection 18c. As shown in FIGS. 2A and 2B, the coils 17a to 17h each include a first terminal wire 19, which is held by the first holding projection 18a and the second holding projection 18b and extended in the axial direction, and a second terminal wire 19, which is held by the first holding projection 18a and the third holding projection 18c and extended in the axial direction.

FIG. 4 shows the commutator 21 as viewed from the brush holder 5. As shown in FIGS. 3 and 4, the commutator 21 includes twenty-four segments 22, a short-circuiting member 23, and a holding portion 24. The holding portion 24 holds the segments 22 and the short-circuiting member 23. The segments 22 are arranged in the circumferential direction. The short- circuiting member 23 includes twenty-four short- circuiting strips 41 so as to short-circuit the segments 22 having the same potential.

As shown in FIG. 4, the twenty-four segments 22 extend radially are arranged at equal angular intervals in the circumferential direction. Each segment 22 is generally wedge-shaped when viewed in the axial direction. Further, each segment 22 has dimensions in the circumferential direction that gradually increase from the radially inward side to the radially outward side. The circumferential interval between adjacent ones of the segments 22 is constant from the radially inward side to the radially outward side.

As shown in FIG. 4, each segment 22 includes a segment main body 31, an inner connection portion 32, an outer connection portion 33, and a coil connection portion 34. The segment main body 31, which is generally wedge-shaped when viewed in the axial direction, is planar and extends in the radial direction. The segment main body 31, as viewed in FIG. 3, has a lower surface facing toward the brush holder 5 and an upper surface 31b facing toward the core 13. The lower surface of the segment main body 31 serves as a slide surface 31a. The slide surface 31a is parallel to the upper surface 31b. Each slide surface 31a is flat and can come into sliding contact with the brushes 7a to 7d.

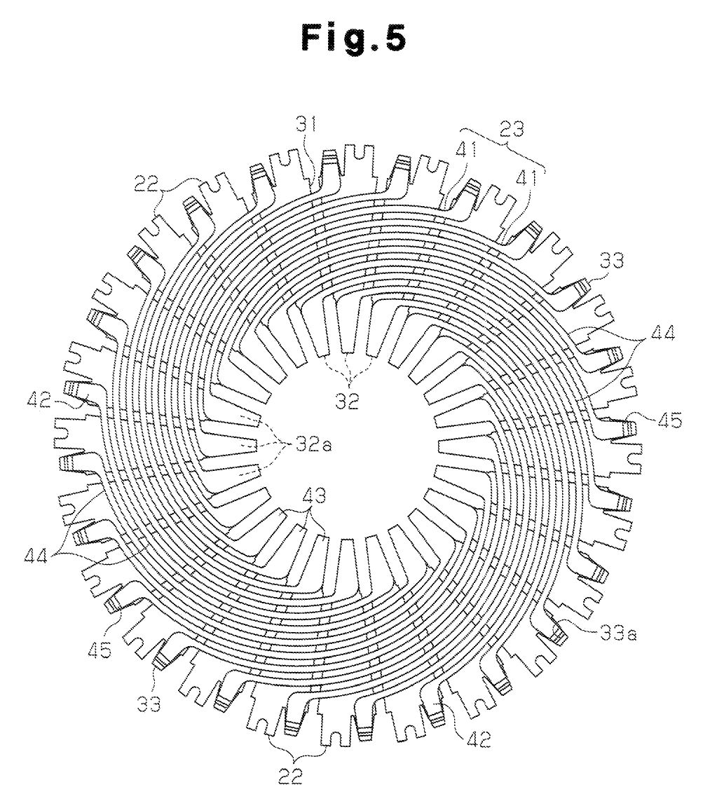

Each inner connection portion 32 is located at the radial inner end of the segment main body 31. The inner connection portion 32 extends slightly upward and then radially inward and parallel to the slide surface 31a as viewed in FIG. 3. The part of the inner connection portion 32 extending parallel to the slide surface 31a is generally trapezoidal so that the width gradually narrows in the radially inward direction when viewed from the axial direction in FIG. 5. The upper surface of the inner connection portion 32 defines an inner connection surface 32a that is parallel to the slide surface 31a. The segments 22 are arranged such that the slide surfaces 31a are flush with one another along one plane and the inner connection surfaces 32a are flush with one another along another plane.

The outer connection portion 33 and the coil connection portion 34 are located at the radial outer end of the corresponding segment main bodies 31. Each outer connection portion 33 extends diagonally upward as viewed in FIG. 3 away from the slide surface 31a. The outer connection portion 33 projects higher than the inner connection surface 32a. The outer connection portion 33 includes an outer connection surface 33a facing a radially inward direction. The angle between the outer connection surface 33a and the upper surface 31b of the segment main body 31 is an obtuse angle.

As shown in FIG. 4, the coil connection portions 34 each include a connection groove 34a that opens radially outward. As shown in FIG. 2B, the first terminal wire 19 and the second terminal wire 19, which extend in the axial direction, are each fitted into and electrically connected to a connection groove 34a.

As shown in FIG. 5, each short-circuiting strip 4l includes an outer short-circuiting end 42, an inner short-circuiting end 43, and a coupling portion 44. The coupling portion 44 couples the inner short-circuiting end 43 and the outer short-circuiting end 42, which are shifted by 120° in the circumferential direction from each other. In FIG. 5, the inner short-circuiting end 43 is shifted by 120° in the counterclockwise direction from the outer short-circuiting end 42. The coupling portion 44 is curved along an involute curve. The outer short-circuiting end 42 is connected to the outer connection portion 33 of the corresponding segment 22. The inner short-circuiting end 43 is connected to the inner connection portion 32 of the corresponding segment 22. The short-circuiting member 23 is arranged on the upper surface 31b of the segment main body 31.

As shown in FIG. 3, a connection strip 45 extends from each outer short-circuiting end 42. The connection strip 45 extends along the outer connection surface 33a. The inner short-circuiting end 43 is trapezoidal like the inner connection surfaces 32a and placed on the corresponding inner connection surface 32a. As shown in FIG. 5, the short-circuiting strips 41 are spaced from one another to avoid contact between one another. The twenty-four short-circuiting strips 41 are formed by pressing a sheet of metal plate, such as a copper plate.

As shown in FIGS. 3 and 5, the twenty-four connection strips 45 are abutted against and electrically connected to the corresponding outer connection surfaces 33a. Further, the twenty-four short-circuiting ends 43 are abut against and electrically connected to the corresponding inner connection surfaces 32a. The short-circuiting strips 41 are flush with the inner connection surfaces 32a, and the coupling portions 44 are parallel to and spaced from the upper surfaces 31b of the segments 22. Thus, the coupling portions 44 do not contact the segment main bodies 31. The short-circuiting member 23 short- circuits the segments 22 that are arranged at an interval of 120° in the circumferential direction.

As shown in FIG. 3, part of the segments 22 and all of the short-circuiting members 23 are embedded in the holding portion 24, which is made of an insulating resin. That is, the holding portion 24 integrally holds the segments 22 and the short-circuiting members 23. As shown in FIG. 4, the outer diameter of the holding portion 24 is substantially equal to the diameter of a hypothetical circle extending along the radial outer ends of the twenty-four coil connection portions 34. As shown in FIG. 1, the outer diameter of the holding portion 24 is larger than the inner diameter of the magnets 2 and smaller than the inner diameter of the motor housing 1. The embedding insulating resin material of the holding portion 24 prevents short-circuiting between the segments 22, short-circuiting between the short-circuiting strips 41, and short- circuiting between the segments 22 and short-circuiting strip 41.

As shown in FIGS. 2B and 4, the outer circumferential surface of the holding portion 24 includes twenty-four arrangement grooves 24b. Each arrangement groove 24b is axially aligned with the corresponding coil connection portion 34. The coil connection portion 34 extends more radially outward than a bottom surface 24c of the arrangement groove 24b. The first terminal wire 19 and the second terminal wire 19 pass through the arrangement grooves 24b for connection to the coil connection portions 34.

As shown in FIG. 3, the holding portion 24 has a central part including an insertion hole 24d that extends in the axial direction. The diameter of the insertion hole 24d is slightly smaller than the outer diameter of the rotation shaft 12. A cylindrical boss 24e projecting away from the segments 22 is formed integrally with the holding portion 24.

Referring to FIG. 1, the rotation shaft 12 is press-fitted into the insertion hole 24d so that the commutator 21 and rotation shaft 12 rotate integrally with each other. The slide surface 31a of each segment 22 defines a plane orthogonal to the axial direction of the rotation shaft 12. The brushes 7a to 7d are pressed against and contacted to the slide surfaces 31a in the axial direction. As the commutator 21 rotates, the brushes 7a to 7d slide along the slide surfaces 31a.

The first terminal wire 19 and the second terminal wire 19 of the coils 17a to 17h are connected to the segments 22. The segments 22 are numbered so that the segment 22 arranged between the tooth 14a and the tooth 14h is segment number “1”. The segment numbers are denoted in the clockwise direction up to “24”. As shown in FIG. 6, the first terminal wire 19 and the second terminal wire 19 of the coils 17a to 17h are each connected to a total of eight pairs of segments 22. The segments 22 that form each pair are adjacent to each other in the circumferential direction. One segment 22 to which the coils 17a to 17h are not connected is arranged between the pair of segments 22.

In the present embodiment, the first terminal wire 19 and the second terminal wire 19 of the coil 17a are respectively connected to the pair of segments 22 denoted as segment numbers “2” and “3”. None of the ends of the coils 17a to 17h are connected to the segment 22 denoted as segment number “4”. The first terminal wire 19 and the second terminal wire 19 of the coil 17b are respectively connected to the pair of segments 22 denoted as segment numbers “5” and “6”. In this manner, none of the coils 17a to 17h are connected to every third segment 22 that are denoted as segment numbers “4”, ”7”, “10”, “13”, “16, “19”, “22”, and “1”. The coil 17c is connected to segment numbers “8” and “9”, the coil 17d is connected to segment numbers “11” and “12”, the coil 17e is connected to segment numbers “14” and “15”, the coil 17f is connected to segment numbers “17” and “18”, the coil 17g is connected to segment numbers “20” and “21”, and the coil 17h is connected to segment numbers “23”, “24”.

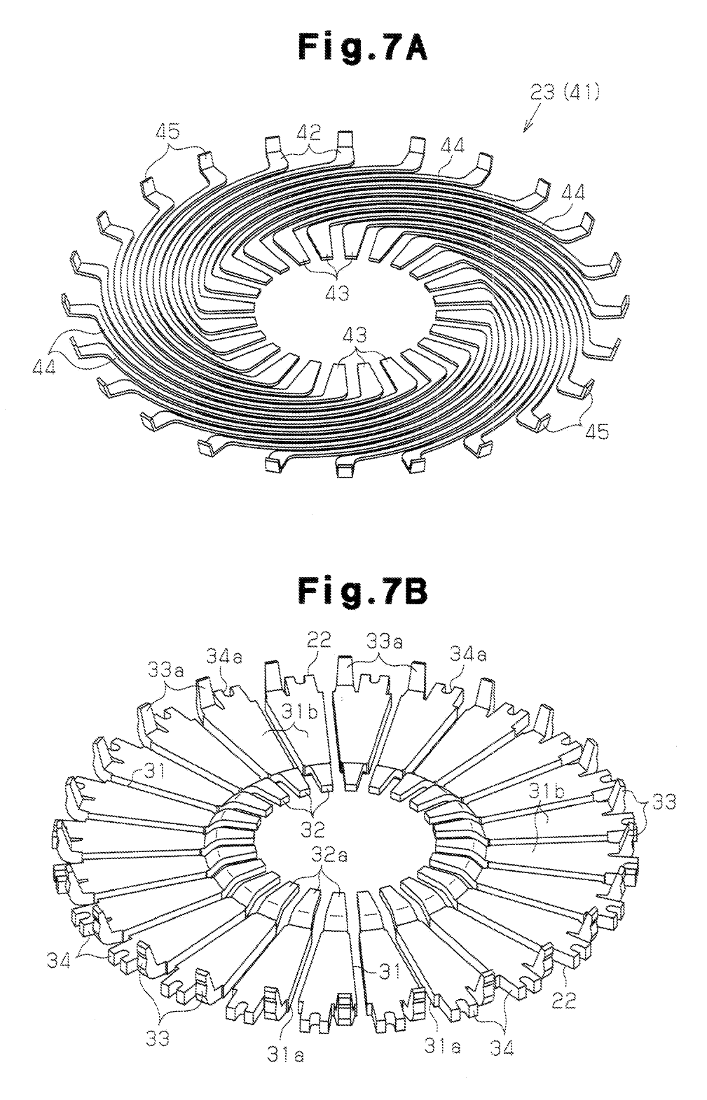

A method for manufacturing the commutator 21 and the armature 11 will now be discussed. The short-circuiting member 23 is first formed in a short- circuiting member formation process. The twenty-four short-circuiting strips 41 shown in FIG. 7A are simultaneously punched out of a conductive plate material such as a copper plate (not shown). Then, the connection strips 45 of the short-circuiting strips 41 are bent and formed.

The segments 22 are formed in a segment formation process, which is a process differing from the short-circuit formation process. The twenty-four segments 22 shown in FIG. 7B are punched out by punching a conductive plate material (not shown). The outer connection portions 33 and the inner connection portions 32 are bent and formed.

In an arrangement process for arranging the short- circuiting member 23 in the segment 22, first the twenty-four segments 22 are radially lined out, and the slide surfaces 31a are arranged to be flush with one another, as shown in FIG. 7B. The twenty-four short-circuiting strips 41 are arranged parallel to the slide surface 31a. As shown in FIG. 5, the inner short- circuiting ends 43 are contacted to the inner connection surfaces 32a, and the connection strips 45 are contacted to the outer connection surfaces 33a. As a result, the short-circuiting strips 41 become flush with the inner connection surfaces 32a. A gap is formed between the upper surfaces 31b of the segment main bodies 31 and the coupling portions 44.

In a joining process, the short-circuiting member 23 is joined with the segment 22. The inner short- circuiting ends 43 are welded to the inner connection portions 32. The connection strips 45 are welded to the outer connection portions 33.

In a holding portion formation process, the segments 22 and the short-circuiting member 23, which have been joined together, are arranged in a mold (not shown). Molten insulating resin material is filled into the mold and then cured to form the holding portion 24. This completes the commutator 21.

Referring to FIG. 8, the rotation shaft 12 is press-fitted into the insertion hole 24d to fix the commutator 21 to the rotation shaft 12. The core 13 onto which the coils 17a to 17h are wound has already been attached to the rotation shaft 12 in this state. The first terminal wire 19 and the second terminal wire 19 are extended through the arrangement grooves 24b and received in the connection grooves 34a of the corresponding coil connection portions 34. Then, the first terminal wire 19 and the second terminal wire 19 are welded from the radially outer side of the commutator 21 and connected to the coil connection portion 34. This completes the armature 11.

The external power supply supplies power to the coils 17a to 17h through the main anode brush 7a and the main cathode brush 7b. This generates a rotating magnetic field with the coils 17a to 17h and rotates the armature 11. Rotation of the commutator 21 sequentially switches the segments 22 that contact the main anode brush 7a and the main cathode brush 7b. Thus, the coils 17a to 17h undergo commutation.

As shown in FIGS. 4 and 6, the sub-anode brush 7c and the sub-cathode brush 7d are arranged so that they are contactable with three segments 22 at certain timings in the present embodiment. For example, the sub-anode brush 7c is arranged so that it extends over one segment 22 and becomes contactable with the two adjacent segments 22 at certain timings. That is, the sub-anode brush 7c is arranged so that as the armature 11 rotates, the sub-anode brush 7c contacts three segments 22 arranged consecutively in the circumferential direction and then contacts only two segments 22 at alternate timings. The main anode brush 7a and the main cathode brush 7b are arranged so that they contact two segments 22 and then contact only one segment 22 at alternate timings as the armature 11 rotates.

The sub-anode brush 7c is arranged more radially inward than the main anode brush 7a. The sub-cathode brush 7d is arranged more radially inward than the main cathode brush 7b. Thus, FIG. 6 schematically shows the main anode brush 7a with a width that is slightly smaller than that of the segments 22, and the sub-anode brush 7c is shown with a width that is the same as that of the segments 22. In the same manner, the main cathode brush 7b is shown with a width that is slightly smaller than that of the segments 22, and the sub- cathode brush 7d is shown with a width that is substantially the same as that of the segments 22. A case in which the brushes 7a to 7d move from the left toward the right in FIG. 6 as the armature 11 rotates will now be described.

The timing at which the sub-anode brush 7c contacts a segment 22 is advanced from the timing at which the main anode brush 7a contacts a segment 22 having the same potential as the segment 22 contacted by the sub- anode brush 7c. In the case of FIG. 6, the timing at which the sub-anode brush 7c contacts the segment 22 denoted segment number “10” is advanced from the timing at which the main anode brush 7a contacts the segment 22 denoted segment number “2”.

In the same manner, the timing at which the sub- cathode brush 7d contacts a segment 22 is advanced from the timing at which the main cathode brush 7b contacts a segment 22 having the same potential as the segment 22 contacted by the sub-cathode brush 7d. In the case of FIG. 6, the timing at which the sub-cathode brush 7d contacts the segment 22 denoted segment number “22” is advanced from the timing at which the main cathode brush 7b contacts the segment 22 denoted segment number “14”. The timing at which the sub-anode brush 7c moves away from a segment 22 is delayed from the timing at which the main anode brush 7a moves away from a segment 22 having the same potential as the segment 22 from which the sub-anode brush 7c moves away. In the case of FIG. 6, the timing at which the sub-anode brush 7c moves away from the segment 22 denoted segment number “9” is delayed from the timing at which the main anode brush 7a moves away from the segment 22 denoted segment number “1”.

In the same manner, the timing at which the sub- cathode brush 7d moves away from a segment 22 is delayed from the timing at which the main cathode brush 7b moves away from a segment 22 having the same potential as the segment 22 from which the sub-cathode brush 7d moves away. In the case of FIG. 6, the timing at which the sub-cathode brush 7d moves away from the segment 22 denoted segment number “21” is delayed from the timing at which the main cathode brush 7b moves away from the segment 22 denoted segment number “13”.

The present embodiment has the advantages described below.

(1) The electrical resistance of the sub-anode brush 7c is higher than the electrical resistance of the main anode brush 7a. The sub-anode brush 7c is arranged more inward in the radial direction of the commutator 21 than the main anode brush 7a. In the same manner, the electrical resistance of the sub-cathode brush 7d is higher than the electrical resistance of the main cathode brush 7b. The sub-cathode brush 7d is arranged more inward in the radial direction of the commutator 21 than the main cathode brush 7b. The slide surface 31a of the respective segment 22 is a plane orthogonal to the axial direction of the direct current motor and generally wedge-shaped, with dimensions in the circumferential direction that increase from the radially inward side to the radially outward side.

Thus, the timing at which the sub-anode brush 7c and the sub-cathode brush 7d contact a segment 22 is advanced from the timing at which the main anode brush 7a and the main-cathode brush 7b contact a segment 22. The timing at which the sub-anode brush 7c and the sub- cathode brush 7d move away from a segment 22 is delayed from the timing at which the main anode brush 7a and the main cathode brush 7b move away from a segment 22.

Therefore, even if a spark occurs in the brushes 7a to 7d, the spark would first occur at the sub-anode brush 7c and the sub-cathode brush 7d. This prevents sparks in the main anode brush 7a and the main cathode brush 7b. Thus, wear of the main anode brush 7a and the main cathode brush 7b caused by sparks is suppressed. Furthermore, the sub-anode brush 7c and the sub-cathode brush 7d have high resistance. Thus, sparks are less likely to occur, and the sub-anode brush 7c and the sub-cathode brush 7d are less likely to be worn even if sparks occur. This extends the life of the brushes 7a to 7d and extends the life of the direct current motor.

The brushes 7a to 7d are identical in shape and size. In other words, the dimensions of the brushes 7a to 7d in the circumferential direction, that is, the brush widths, may all be the same. The circumferential interval between the sub-anode brush 7c and the main anode brush 7a may be set to be the same as the circumferential interval between the segments 22 having the same potential. In the present embodiment, the circumferential interval between the sub-anode brush 7c and the main anode brush 7a may be set to be 120° . That is, a position adjustment for shifting the circumferential interval between the sub-anode brush 7c and the main anode brush 7a by a slight shift amount from the circumferential interval between the segments 22 of the same potential is unnecessary in the present embodiment. In the same manner, the circumferential interval between the sub-cathode brush 7d and the main cathode brush 7b may be set to 120° in the present embodiment.

The setting of the circumferential interval between the sub-anode brush 7c and the main anode brush 7a to be the same as the circumferential interval between the segments 22 having the same potential is referred to as “arranging the sub-anode brush 7c and the main anode brush 7a at normal positions”. The present embodiment prevents sparks from occurring in the main anode brush 7a and the main cathode brush 7b when the sub-anode brush 7c and the main anode brush 7a are arranged at the normal positions. This facilitates the setting of the arrangement and dimensions of the brushes 7a to 7d.

(2) The sub-anode brush 7c and the sub-cathode brush 7d are formed about 100% by graphite powder without using copper powder and thus differ from the main anode brush 7a and the main cathode brush 7b. This simplifies the formation of the sub-anode brush 7c and the sub-cathode brush 7d, which have a higher resistance than the main anode brush 7a and the main cathode brush 7b.

(3) The short-circuiting member 23 causes the segment 22 that is in contact with the sub-anode brush 7c to have the same potential as the segment 22 that is in contact with the main anode brush 7a. In the same manner, the short-circuiting member 23 causes the segment 22 that is in contact with the sub-cathode brush 7d to have the same potential as the segment 22 that is in contact with the main cathode brush 7b. Thus, the degree of freedom for the arrangement of the brushes 7a to 7d is high.

(4) The main anode brush 7a, the main cathode brush 7b, the sub-anode brush 7c, and the sub-cathode brush 7d all are identical in shape and size. That is, the distal end surfaces of the brushes 7a to 7d that come into contact with the commutator 21 are all identical in shape and size. Such brushes 7a to 7d can be easily formed.

(5) The segments 22 are generally wedge-shaped. The brushes 7a to 7d are each box-shaped, and the distal end surfaces of the brushes 7a to 7d that contact the segments 22 are each rectangular. The short side of the distal end surface of each of the brushes 7a to 7d extends parallel to the radial direction. Thus, the area of contact area between the brushes 7a to 7d and the segments 22 gradually changes as the brushes 7a to 7d start to contact the segments 22 and the brushes 7a to 7d move away from the segments 22. This further suppresses sparks in the brushes 7a to 7d.

(6) The sub-anode brush 7c and the sub-cathode brush 7d are not connected to the external power supply and are thus in a non-power supplied state. That is, there is no need to wire power supply lines to the sub- anode brush 7c and the sub-cathode brush 7d. This simplifies the structure of the direct current motor.

The above embodiment may be modified as described below.

Copper powder may be mixed in the sub-anode brush 7c and the sub-cathode brush 7d. However, the proportion of graphite powder mixed in the sub-anode brush 7c and the sub-cathode brush 7d should be greater than the proportion of the graphite powder mixed in the main anode brush 7a and the main cathode brush 7b. This is so that the electrical resistance of the sub-anode brush 7c and the sub-cathode brush 7d is higher than the electrical resistance of the main anode brush 7a and the main cathode brush 7b.

The main anode brush 7a and the sub-anode brush 7c may be arranged to contact the same segment 22. A combined brush including a double-layer structure in the radial direction may be formed by integrating the main anode brush 7a to the sub-anode brush 7c in the radial direction. In this case, an insulating layer may be arranged between the main anode brush 7a and the sub-anode brush 7c.

In the same manner, the main cathode brush 7b and the sub-cathode brush 7d may be arranged to contact the same segment 22.

The sub-anode brush 7c and the sub-cathode brush 7d may be connected to the external power supply.

The segments 22 that are spaced apart by 120° do not have to be short-circuited by just one short- circuiting strip 41 and may be short-circuited by two short-circuiting strips. The two short-circuiting strips are connected at positions spaced apart by 60° from the two segments 22 that are spaced apart by 120°. Further, the circumferential interval between the segments 22 that are to be short-circuited is not limited to 120° and may be determined in accordance with the structure of the direct current motor.

The main anode brush 7a, the main cathode brush 7b, the sub-anode brush 7c, and the sub-cathode brush 7d do not all have to be identical in shape and size. The dimensions of the brushes 7a to 7d in a direction orthogonal to the distal end surface may be different while keeping the distal end surfaces of the brushes 7a to 7d identical in shape and size. The distal end surfaces of the brushes 7a to 7d do not have to be rectangular and may be trapezoidal.

The short-circuiting member 23 may be eliminated from the commutator 21 of the direct current motor.

What is claimed is:

1. A direct current motor which defines an axial direction and a radial direction, the direct current motor comprising:
a commutator including a plurality of segments, with the segments being arranged in a circumferential direction, and each of the segments including a slide surface defined by a plane orthogonal to the axial direction; and
a power supply brush pressed against and contacting the slide surface, the armature being supplied with power for rotation from the power supply brush via the commutator, the power supply brush including a main brush and a sub-brush, wherein the sub-brush has electrical resistance that is higher than that of the main brush, at least the main brush supplies the armature with power, and the sub-brush is arranged more inward in a radial direction of the commutator than the main brush.

2. The direct current motor according to claim 1, wherein:
the main brush is formed by mixing and sintering graphite powder and copper powder; and
the sub-brush is formed by mixing and sintering the graphite powder and the copper powder with the proportion of the graphite powder being greater than in the main brush or formed by sintering only the graphite powder without using the copper powder.

3. The direct current motor according to claim 1, wherein:
the commutator includes a short-circuiting member for causing the segments spaced by a predetermined angular interval to have the same potential; and
the sub-brush is arranged to contact the segment having the same potential as the segment that is in contact with the main brush.

4. The direct current motor according to claim 1, wherein the sub-brush is arranged to contact the segment that is in contact with the main brush.

5. The direct current motor according to claim 1, wherein the main brush and the sub-brush each have a distal end surface that comes into contact with the slide surface, with the distal end surfaces being identical in shape.

6. The direct current motor according to claim 1, wherein the main brush and the sub-brush each have a distal end surface that comes into contact with the slide surface, with the distal end surfaces each being rectangular.

7. The direct current motor according to claim 1, wherein:
the main brush is directly connected to an external power supply; and
the sub-brush is not connected to the external power supply.
